(19) United States
(12) Patent Application Publication
(10) Pub. No.: US 2004/0182680 A1
(43) Pub. Date: Sep. 23, 2004

(54) Pallet changing system

(76) Inventor: Hinrich Stave, Mindelheim (DE)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/393,014

(22) Filed: Mar. 21, 2003

(51) Int. Cl. B65G 49/02

(52) U.S. Cl. 198/346.1

(57) ABSTRACT

The invention relates to a pallet changing system for changing the pallet carrying the workpiece in a machine tool, in particular in a machining center.

The invention is characterised in that the carrier is designed in such a way that it serves for connecting the pallet with the carrier by means of the movement of the machining table.

### BACKGROUND OF THE INVENTION

The invention refers to a pallet changing system for changing the pallet bearing the workpiece which has to be machined in a machine tool, in particular in a machining center, wherein a carrier, which can be driven, moves the pallet between a machining table in the machine tool and a set-up point outside the machine tool. Furthermore the invention refers to a method for changing a pallet in a machine tool, in particular in a machining center, the pallet being pulled off (moved back) from the machining table in the machine tool by means of a carrier to a set-up point outside the machine tool.

Pallet changing systems as mentioned above serve for automatically conveying devices, respectively workpieces, which are clamped on a pallet into the machine tool and, after finishing the machining, to remove them from the machine tool again, that is to pull them off. The workpiece is mounted to the pallet on the set-up point outside the machine tool, frequently at least two set-up points being provided, in order to obtain a machining as continuously as possible by means of the machine tool. While a first workpiece is machined on a first pallet in the machine tool, already the next workpiece is prepared on the set-up point.

A carrier, which is, for example, fastened to a roller chain, serves for the movement of the pallet between set-up point and machining table.

If the chain drive is arranged stationary, with rotatable circular tables as machining tables a very long claw, into which the carrier engages for transportation purposes, is necessary at the pallet. However, this claw disturbs the machining because it obstructs the close approach of the machining unit to the table. Furthermore one end of the chain drive is located in the working area so that chips can be caught in it, a covering of the chain drive is difficult.

Furthermore chain drives are known which can be driven in longitudinal direction. By means of that it is possible that the pallet claw can be designed shorter, however, it remains an obstructing contour which projects over the measurement of the pallet. During machining the chain drive is outside the working area, however, this is realised with a considerable technical effort for the approach of the movable chain drive.

The above-mentioned solutions according to the prior art have in common that the time for changing the pallet is comparatively long. This results from the fact that the carrier can only be brought into engagement after the table has been brought into the position for changing the pallet. This can, according to the prior art, be carried out only at the end of the machining process, when the machining table has brought the clamped pallet into the changing position; a connection of the carrier with the pallet, respectively the claw, cannot be carried out earlier.

From the printed matter EP 0 000 874 A1 a machining device is known with a common drive for the working table and the pallet changing device. The pallet changing device here has two extension arms, which convey the pallet either into or out of the working area of the machining device. For that purpose the pallet changing device carries out a movement for conveying the pallet. This conveying is carried out when the arm of the pallet changing device pushes against the pallet, the pallet being moved along rails which lead the pallet up to the working area. While the pallet is in the working area of the machining device for machining the pallet changing device is moved back.

For the change of the pallets from the working area and the introducing of a new pallet into the working area the pallet has then to be guided back again into the changing position. The pallet changing device can then guide out the pallet, which just has been machined, of the working area and simultaneously guide a new pallet into the working area. Here the system is located in any case outside the working area, which is a disadvantage because additional space has to be provided for, and the workpiece is moved during a longer period of time, during which time no machining can be carried out leading to less efficiency, respectively cutting performance.

Another disadvantage is, that by means of the fork formed by the two arms of the pallet changing device a maximum measurement for a pallet is defined. Thus the machining device is limited concerning the machining of certain workpieces with respect to the measurement of the size of the pallet itself. Another disadvantage in the solution described above results from the fact that the pallet is placed by means of the pallet changing device only non-positive, respectively through the pushing of one of the extension arms against the pallet. An exact positioning is not possible. For that exact fixing means have to be provided, if necessary.

Another disadvantage of the thus known solution according the European Patent Application results from the fact that the pallet carrying the workpieces are transported through the working area. That means that they are supplied on the one side of the working area and subsequently transported out on the other side of the working area. This also includes certain losses of time which altogether lead to a comparatively long time for changing the pallets.

### SHORT ABSTRACT OF THE INVENTION

In view of that prior art it is the object of the invention to suggest, on the one hand, a pallet changing system and, on the other hand, a method for changing a pallet which allows a clearly faster changing of the pallets.

This object is achieved by suggesting a pallet changing system, as described above, in such a way that the movement of the machining table serves for connecting the pallet with the carrier. The method according to the invention proposes that on pulling off the pallet at first the carrier is positioned in the working area of the machine tool and subsequently the pallet is connected with the carrier by means of a movement of the machining table and then the carrier pulls the pallet to the set-up point.

The proposal according to the invention aims at obtaining an acceleration of the changing process to the effect that during or immediately after the end of the actual machining of the workpiece the carrier is already positioned in the working area. In addition to this first step, which already leads to a certain saving of time during the changing of pallets, it is provided independently that the movement of the machining table is used for connecting the pallet with the carrier. In the known devices, respectively systems, here always an order, defined by the control, has to be kept which has been necessary because of the chain drive. At first the chain drive took for granted that the pallet had been arrived in the changing position in order to thread the carrier through that into the claw. However, if for connecting the pallet with the carrier the final movement of the machining table from the machining position into the changing position (in the machine tool) is used, this time segment for changing may be correspondingly shortened, respectively used double, leading to a correspondingly shorter time for the change.

By means of the suggestion according to the invention already an acceleration of the changing time has been reached. In comparison with the chain changing devices, which can be driven, about 40 percent of the changing time are saved using the suggestion according to the invention. However, if the changing procedure is carried out faster, more machining steps, respectively workpieces, can be machined per time unit, if otherwise the arrangements remain the same, and the performance of accordingly equipped machining centers according to the invention is improved.

As the carrier reaches inside the working area, space is saved because the connecting of the pallet with the changing device is, in contrast to the solution according to the prior art, carried out in the working area and does not need extra space.

In a preferred embodiment of the invention it is provided that the carrier is, during the connecting with the pallet, beneath the pallet and the pallet, respectively a coupling part or a claw at the pallet, is connected, respectively threaded, to the carrier by means of a movement of the pallet through the machining table. It is suggested here that the movement of the machining table, in particular at the end of a corresponding machining process, is used for threading, respectively for connecting, the pallet with the carrier. Naturally it is necessary for that that in this case the carrier is already positioned in the working area so that the pallet can then be moved via the carrier in order to make threading, respectively coupling, possible. However, the result from that is that already during or shortly after the end of the machining the carrier is introduced into the working area, which was not possible in the known solutions. If, however, the carrier is positioned so early another saving of time results, because the corresponding approach of the carrier is carried out parallel to the movement of the table into the changing position.

According to a convenient development of the pallet changing system according to the invention it is provided, that the carrier is arranged on a slide which can move on a guide rail. Therefore it becomes possible that the carrier can already be positioned in the working area during or shortly after the end of the machining process without disturbing the machining itself. Here the guide on a guide rail serves for an exactly positioned guide of the carrier resulting also in a reducing of the time for changing the pallets.

According to the invention it has also been found that it is advantageous if, for connecting the pallet with the carrier, a claw is arranged below the pallet. Here it is furthermore advantageous if this claw is arranged hidden and does not project from the pallet, respectively out of the pallet. This serves in particular for a safe connection of the pallet with the carrier, making sure that the claw does not become e. g. soiled by the chips which are produced during machining.

Here it is furthermore an advantage if the connection between the pallet and the carrier is effected by an interlocking connection. This interlocking connection of carrier and pallet may be used for a very exact positioning of the pallet in the working area, respectively on the set-up point.

Another aspect of the invention is given by the fact that for the guide of the slide a guide rail is provided and a driving unit drives the slide via the driving spindle.

According to an advantageous development of the pallet changing system according to the invention it is provided that here the carrier is linear designed rectangular to the direction of movement of the slide, in order to achieve a lateral, preferably rectangular, threading of the pallet via the claw to the carrier.

It is furthermore convenient if a frame is provided which supports the pallet outside the machine tool and forms the set-up point.

Furthermore it is advantageous if the frame has a channel for receiving the carrier drive. In that way a very space saving arrangement of the pallet changing system according to the invention on a machining unit can be obtained.

According to a convenient development of the pallet changing system according to the invention at least two set-up points per machine tool are provided.

It is preferred here if these two set-up points are arranged parallel in front of the working area, respectively the machine doors, in such a way that the changing of pallets is carried out each time out of, respectively into, the working area to the same set-up point from which the pallet has been conveyed into the working area. In contrast to the prior art the workpieces, respectively pallets, now are not transported anymore, according to the invention, through the machining unit, but they are conveyed from the set-up point into the working area, machined there and after the end of the machining they are transported back to the same set-up point from which they have been transported into the machine. Simultaneously on a second set-up point another pallet can be equipped with workpieces which have to be machined, so that, without delay, after the machined workpiece together with the pallet has been transported out of the machining unit, the next workpiece is subsequently transported on a second pallet into the working area through a machine door which is arranged there. By means of this changed concept of a machine it can be obtained that the reduction of the pallet change already given by the design of the carrier and the claw, can be reduced further. It goes without saying that even more set-up points can be provided in front of the machining unit so that the machining unit can be used even more effective.

Another aspect of the pallet changing system according to the invention is given by the fact that the carrier grasps the pallet on its side which is opposite to the machining spindle of the machine tool. This should guarantee in particular that the connection between the carrier and the pallet is not obstructed by soils, which could possibly soil the carrier.

A further development of the invention is characterised by an indexing or defining the pallet on the set-up point.

According to the invention it is also convenient if the frame at its side facing the pallet and/or if the base of the channel has a surface which is diagonally inclined, respectively lowered, in the direction of the machine tool.

In another preferred embodiment of the invention it is provided that the positioning of the carrier in the working area is carried out when the machine door is still closed or almost closed. As it will be described later on it is provided that the carrier grasps the pallet on its off-center region. With a corresponding construction it is possible to open the machine door only a gap in order to position the carrier in the working area. This gap is opened only so wide that it is sufficient for introducing the carrier into the working area.

However it is also possible that the machine door has an opening, which may also be locked if necessary, for the carrier, so that that can be positioned in the working area when the machine door is otherwise closed. For example an appropriate cutout is provided in the lower region of the machine door which allows, on the one hand, to introduce the carrier and, on the other hand, does not obstruct the movements of the machine door, in particular the sliding movement during the opening of the door.

The measurements mentioned above eventually serve for saving time, respectively for carrying out different steps parallel, in order to reduce the time necessary for changing the pallet to an absolute minimum.

The invention does not only refer to the pallet changing system, respectively the method for changing a pallet, but it also refers in the same way to a pallet for which protection can be searched in the following independently or also dependently from the objects mentioned above. Therefore it is provided to combine all features of this application, if necessary focused on their use in a pallet, as an object essential for the invention.

In particular this pallet is used in a pallet changing system, as described in the beginning, the pallet having guide means for a guide of the pallet between the set-up point and the machining table, which are designed, for example, as a groove or as a T-like groove. These guide means act together with the corresponding guide rails which are arranged at the frame, which also carries the carrier and its drive.

According to a convenient development of the pallet according to the invention, respectively the pallet changing system according to the invention, it is provided that at the guide rail for the pallet a dismountable tilt resisting strip which engages with an undercut of the guide groove of the pallet.

It is particular advantageous here if a safety switch is provided at the tilt resisting strip.

According to a preferred development of the invention it is furthermore provided that the drive of the carrier is designed hydraulic, servopneumatic or electric or electromagnetic, and pulling means, in particular belts or chains or pinion rack drives, threaded spindles, linear motors or servodrives are used.

Furthermore the pallet has a claw which serves for connecting the pallet with a carrier for transport purposes. This claw, which is generally also called coupling part or connection part, serves for producing an interlocking connection with the carrier in order to be able to move the pallet with the carrier correspondingly. Via this interlocking connection the force for the movement is subsequently introduced from the carrier to the pallet during transporting in, respectively out. Therefore, in particular, a very safe and exactly positioned connection is given, which has clear improvements compared with the solutions known from the prior art. A successful positioning, which is sufficiently exact, of the pallet in the working area for the following transport and/or machining tasks can be carried out.

It is known in the prior art to design this claw projecting over the contour or the horizontal projection of the actual pallet in order to give the known chain drives an opportunity to grasp the claw. The design in the prior art is in particular a disadvantage if comparatively small workpieces are clamped on the pallet. Then the claw obstructs the close approach of the machine, respectively the machine spindle, to the pallet, long tools are necessary. Furthermore the projecting claw limits also the approach of the tool spindle to the pallet, that is if the claw is not positioned exactly in the center at the pallet. Namely, if the machining unit is arranged directly in front of the claw, the machining unit has to be moved back a little before the pallet can be pivoted. It has to be taken into consideration here that the claw, if arranged off-center, has a larger pivoting radius and that is why the machining unit is in the way. The further development according to the invention, however, allows the realisation of space saving machine tools as the space which is needed for the pallet can be reduced if there is no projecting claw at the pallet. This leads to a considerable gain of space, on the one hand, in the construction form of the machine tool, respectively the complete machining center (for example for its transport), but, on the other hand, also in the space needed in the concerned hall.

Furthermore this embodiment has the advantage with regard to the functionality. The known claws projecting beyond the pallet regularly lead to the problem that also on the projecting claw arms chips can lie, which can, under certain circumstances, obstruct or hinder the coupling procedure.

The suggestion according to the invention proposes that now the claw is arranged below the pallet. By means of this design it is achieved that the claw is arranged space saving at the pallet and thus altogether less space is needed. However, as the claw itself is protected by the pallet, also the risk of soiling by chips flying around and so on is reduced clearly, may be even eliminated, which leads to a higher reliability of operation.

In a preferred embodiment of the invention rinsing nozzles for liquid and/or gaseous cleaning agent are provided at the pallet. The rinsing nozzles serve for cleaning the pallet itself or the surfaces of the pallet or other objects or regions from soil or chips and so on. The invention is used in particular with cutting machines, the soiling problem. On the one hand, existing here, on the other, hand, however, a high or very high precision in the machining being demanded. However, this high precision may be disturbed by chips, which, for example, lie close to the corresponding clamping means and thus make a highly precise clamping impossible. It is strived for regularly, that the chips are washed away into the chip transport channel and disposed of. On the one hand the solution according to the invention allows a sort of self-cleaning of the pallet by means of the nozzles provided, through which either liquid cleaning agent, for example cooling liquid as it is usual with machine tools, is guided, or gaseous cleaning agents are applied, for example compressed air and the like. On the other hand, it is also provided, that the pallet, when moved, cleans the way itself and thus avoids a carrying over of chips out of or into the machine tool, in particular to the clamping points on the machining table and so on. Therefore it is provided in a preferred embodiment of the invention that the rinsing nozzles which are each time arranged in front seen in the transport direction of the pallet, are supplied with cleaning agent.

It is convenient to provide in this case in the pallet a corresponding system of conduits for the cleaning agent, for example appropriate conduit borings, the desired nozzles being reached by appropriate valves or other drives.

In a preferred embodiment of the invention it is also provided that on the carrier at least one connection for liquid and/or gaseous cleaning agent is provided and the cleaning agent reaches the rinsing nozzle of the pallet via the connection when the carrier co-operates with the pallet. Therefore the carrier is not only provided with the function of power transmission, but it has also another function. The carrier serves as a connecting part in order to be able to supply the pallet with the corresponding cleaning agent. If several connections are provided, thereby the nozzles in the front or back region of the pallet can be reached without any problems by means of a corresponding drive depending on the purpose of use and so on. Simultaneously the connection to the connecting part is produced automatically by connecting the carrier with the pallet and improves the reliability of the process of the whole invention, either that of the pallet changing system or of the correspondingly designed pallet.

In a preferred embodiment of the invention it is provided that the control parameters of the carrier drive can be changed load-controlled. By means of that it is achieved that for example a movement of the pallet independently from the load of the pallet is carried out always with the same speed.

Furthermore the invention provides that for threading, respectively separating, of the carrier the movement of the carrier is controlled interpolating with the movement of the table. It is, for example, provided that the movement of these two elements is coordinated with each other. Thus, when the machining on the pallet is finished and the pallet should be positioned for transporting out, simultaneously the drive of the carrier is activated in order to achieve an approach of the two elements, which is positively influenced by each other. It may be convenient here that the respective speeds are coordinated with each other or the respective end positions are reached in a certain (time) relation to each other.

It is an advantage if the carrier can be separated from the pallet when the pallet stands on the set-up point. It is, for example, provided that the pallet is removed from the pallet changing system (for example for more extensive mountings and so on). For that purpose the carrier, which remains, as said before, with the pallet changing system, is removed from the pallet.

It is convenient if a rotatable set-up point is provided. This allows to rotate the pallet and position it in such a way for example for assembly purposes. If necessary the pallet has also on its lower surface two or more claws in order to co-operate in an ideal way with the carrier. Also for rotating the pallet it is convenient that the carrier can be separated from the pallet, however, this is not a requirement, because also in another embodiment according to the invention it is suggested that the pallet can be rotated on the set-up point around the carrier. In this case an uncoupling of carrier and pallet during the rotation is not necessary. Preferably the carrier grasps the pallet in this case in the center. The rotation of the pallet over the carrier, however, is not limited to that. It goes without saying that a twisting around the carrier is also possible in another arrangement.

In the case that the carrier and the claw are not separated when the pallet is rotated, it is provided that claw and carrier are designed in such a way that their operative parts are formed by the surfaces of a cylinder. If necessary it is also provided in this case that for threading the pallet to the carrier a combination of linear movement and rotation of the table is provided.

In the sub-claims additional developments according to the invention are described. Furthermore the invention is shown in the drawings.

### BRIEF DESCRIPTION OF THE DIFFERENT VIEWS OF THE DRAWINGS

The figures show:

FIG. 1: in a three dimensional view the pallet system, respectively machining center, according to the invention;

FIG. 2: also in a three dimensional view an element of the pallet changing system according to the invention;

FIG. 3: in a side view a detail of a pallet changing system according to the invention.

### DETAILED DESCRIPTION OF THE PREFERRED EMBODIMENT

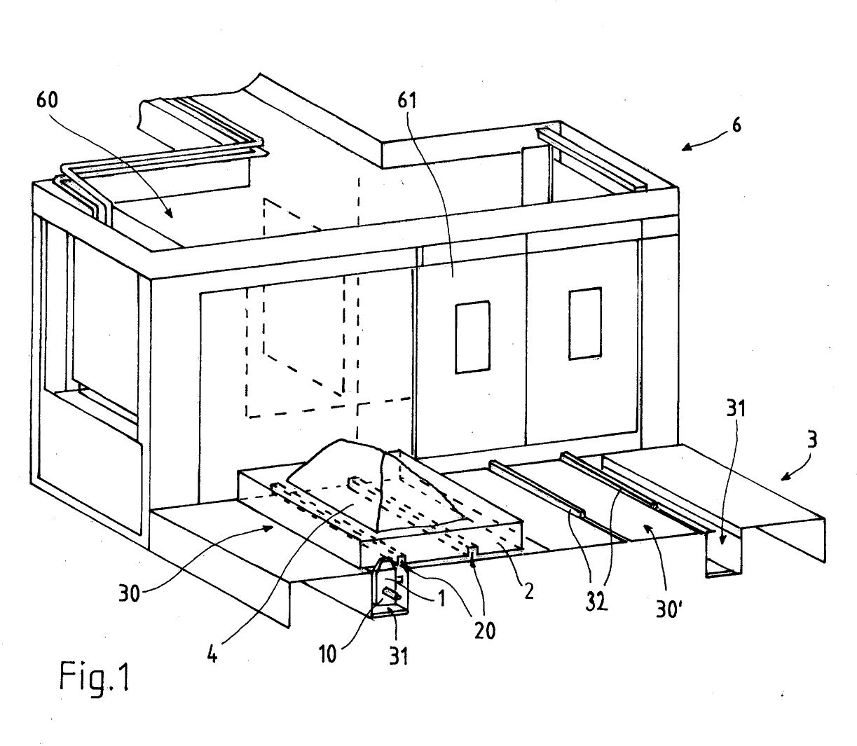

The invention is shown schematically in FIG. 1.

FIG. 1 shows a machining center according to the invention with a machine tool 6 for machining workpieces 4 clamped on pallets 2. Furthermore a pallet changing system is realised here which takes care that the pallets 2 with clamped-on, but not yet machined workpieces 4, are conveyed into the working area 60 of the machine tool 6 and finished workpieces 4 are transported over the pallet 2 out of the machine tool 6. It is desired that the operation of a corresponding machining is carried out automatically, even fully automatically, that means that the prepared workpieces are clamped on the pallet and conveyed by it automatically into the machine tool, when they are needed correspondingly. Accordingly the pallets are conveyed out automatically, when the machining is finished.

The machine tool 6 has two machine doors 61. In the drawing shown in FIG. 1 the left hand door has been pushed to the side, that means opened, in order to be able to convey the pallet 2, which lies in front of it, into the working area 60. The shown situation thus corresponds just with the second part of the changing process, that is the part where a pallet, which has been prepared earlier, is guided back again into the machine tool. For more clearness the right hand pallet is not shown in FIG. 1; on this set-up point actually a pulled out pallet is supposed to be.

In front of the machine tool 6 there is a frame 3, which supports the set-up points 30, 30′. On the set-up points 30, 30′ the workpieces 4, which have to be machined, are mounted on the pallet 2 and constructed. The frame 3 has guide rails 32 which co-operate with corresponding grooves 20 of the pallet 2 in order to guide the pallet 2.

The drive for the movement of the pallet 2 is arranged in the channel 31. Here the channel 31 takes up the carrier drive 11 and extends parallel to the guide rails 32 below the pallet. The carrier drive 11 drives a carrier 1 movable in longitudinal direction. This carrier 1 serves for a pull-off or conveying in movement of the pallet 2, either out of the machine tool 6 or into it.

Here the carrier 1 sits on the slide 10. The slide 10 is driven for example on a driving spindle 12 movable in longitudinal direction.

According to the invention a plurality of different drives of the carrier 1 are suggested. They can be designed, for example, hydraulic, servopneumatic or electric. Gears may be used, for example pulling means (belts, chains), pinion-rack-systems or threaded spindles 12. Also the use of linear motors is possible, in this case a gear is not necessary.

Advantageously the drive is equipped with a servodrive. By means of that speed and acceleration can be chosen load-controlled. Furthermore the movement of the slide can be combined with the movement of the machining table (arranged in the working area 60, not shown in the figures). By means of that it is obtained that according to the movement of the machining table the carrier 1 can already be positioned.

A frame 3 is provided which supports the pallet 2 outside the machine tool 6 and forms the set-up point 30, 30′. In the example shown here two set-up points 30, 30′ are provided for the machine tool 6. It is possible to arrange more set-up points per machine tool, it depends from the respective application.

An indexing or definition of the pallet 2 on the set-up point 30 is provided. This may be carried out for example by corresponding bolts or a catch, or the carrier drive 11 holds the slide 10 in an appropriate position. By means of that an undesired movement of the pallet is avoided safely. In addition to that a mechanic limitstop can be provided.

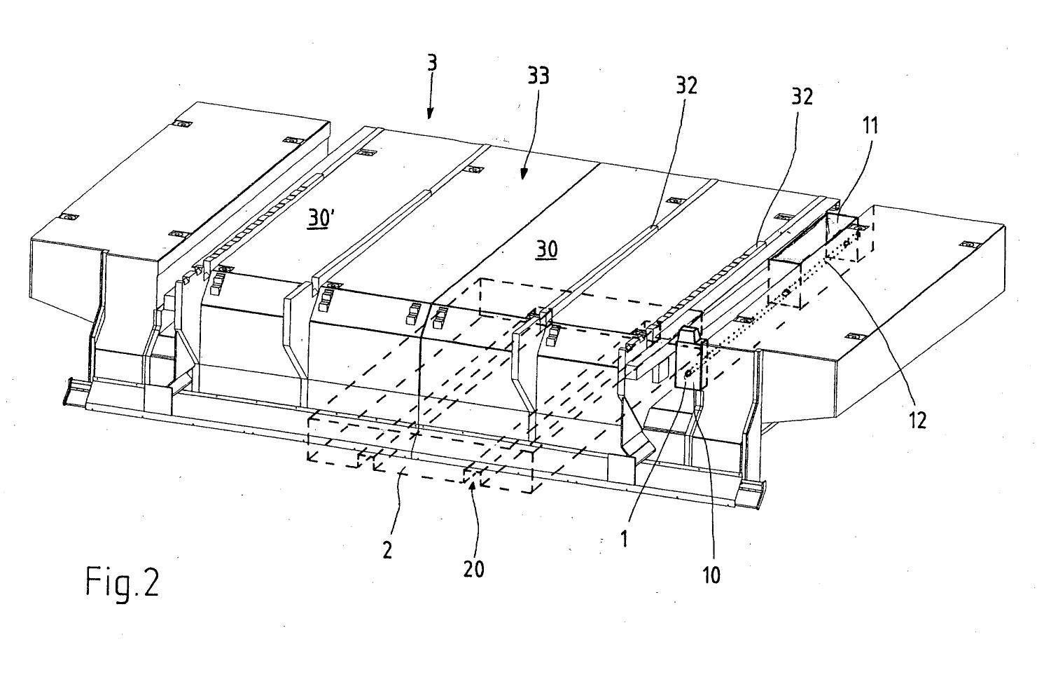

In FIG. 2 the frame 3 of the invention is shown as a single element. The chosen view is selected with regard to the machine tool 6 out of it. The pallet 2 pushed forward from the set-up point 30 into the machine tool 1 (not shown) is indicated with a broken line.

As a rule the machining spindle of the machine tool 6 is arranged in the center with regard to its housing. The pallet 2 is conveyed into the machine tool from the set-up point 30 and taken over there by a machining table and guided to the corresponding machining at the tool spindle. According to the invention it is suggested that the movement of the machining table serves for connecting the pallet 2 with the carrier 1. Conveniently here the carrier 1 will grasp the pallet 2 at its off-center region. By means of that it is achieved that no collision of the movement of the machining table with the carrier 1 occurs during the machining. Conversely the carrier 1 can be positioned already then in the working area 60 while the actual machining of the workpiece 4 has just been finished. Therefore it is also convenient, if the carrier 1 grasps the pallet 2 on its side which is opposite to the machining spindle of the machine tool 6. In this case the machining table moves the pallet completely to the side until exactly this carrier 1 grasps the pallet 2, for example a claw or a coupling element not shown. Simultaneously it can often be assumed that this extreme pull-out of the machining table occurs only in very few machining cases and therefore an obstruction or disturbance of the usual operation can be excluded almost completely.

For the case that the longitudinal traverse of the table is used frequently for the machining it can also be provided that the longitudinal traverse is extended beyond the measure necessary for the machining. By means of that the path for threading the carrier is created.

Therefore also the arrangement symmetric with reference to the center plane of the channels 31 occurs, the carrier drive 11 of the two set-up points.

The arrangement of the two drives each on the side end of the table traverse has the additional advantage that the space between the pallet guides 32 remains free and on this point a rotation device for the pallet at the set-up point can be arranged.

In order to achieve that the rinsing liquid and so on which occurs on the surface 33 of the frame 3 runs away safely, it is provided that the frame has on its side facing the pallet a diagonal surface inclined in the direction of the machine tool, so that liquid can run away in the direction of the machine tool 6 and is taken up and handled there by means of the any way provided rinsing means circle.

In the preferred embodiment of the invention it is provided that the channel 31 has on its side facing the pallet 2 an elastic sealing which can recede during a movement of the carrier 1 in the region of the carrier 1. For that purpose it is provided for example that a rubber lip bent essentially L-like is arranged on both sides of the edge of the channel 31 and this rubber lip allows the sword-like carrier projecting upward to penetrate and is pressed down by it. In the rest of the region, however, the rubber lip covers the channel 31 and thus prevents dirt or other articles from falling into the channel 31.

Furthermore it is provided that the channel 31 is protected by a lateral door/shutter against the penetrating of chips from the working area 60. This door is opened, for example, by a radial cam on the slide 10 and closed by a spring. However, also another compulsory control may be provided. In order to save a position inquiry of the door it is provided that the machine door 61 can only be closed when the channel shutter or door is closed.

In a preferred embodiment of the invention a cleaning device is provided in order to keep the lower surface of the pallet and/or the upper surface of the frame 33 free of chips or the like. This cleaning device serves for preventing the chips from obstructing the pallet changing process. For this purpose several different measures, which can also be applied single, are suggested. For example, a stripper, which is supported on a slide and driven by the carrier drive 11, is provided as a cleaning device. This stripper is moved together with the carrier and brushes over the surface and removes the corresponding chips from there. As an alternative it is provided that the cleaning device has an arm with rinsing nozzles for liquid and/or gaseous cleaning agents which is supported by a slide and can be driven by the carrier drive 11.

According to the invention it is provided here that the cleaning device is arranged on a second independent slide or is connected with the slide of the carrier 1.

It is also possible that in the pallet corresponding nozzles are provided in order to rinse the pallet, respectively the supporting surfaces or regions, appropriately. It is also possible to clean the claw on the pallet co-operating with the carrier 1 appropriately. Parts of the guide, which project into the working area, are cleaned, for example, by nozzles which are arranged in the machine door 61.

In order to protect the pallet 2 against tilting even with an unfavourable situation of the center of gravity of workpieces 4, a tilt resisting strip is arranged at the guide rail 32 which in particular engages with an undercut of the guide groove 20 of the pallet. Usually the pallets have a T-shaped groove and the undercut formed by the T serves for co-operating of the tilt resisting strip with the pallet. Thus eventually the tilt resisting strip engages interlocking with the groove 20 of the pallet. It is provided here that that strip can be dismounted so that the pallet can be exchanged or transferred into or out of the system. For that purpose e. g. a crane may serve.

In order to prevent the pallet changing device, respectively the system according to the invention, from being operated despite the rail being dismounted, a safety switch is provided which co-operates definitely with an element at the rail. Preferably the safety switch is proximity and the element has a corresponding code carrier for a definite drive. The control releases the operation of the system only when the safety switch recognises the mounted rail.

An advantage of the invention is the fact that there are no function elements on the frame besides the guides 32 and the carrier 1. Therefore the frame can be provided with a walk-on cover from which only the guide 32 and the carrier 1 (at the respective lip sealing) project. By means of that a surface as even as possible is realised which can be walked on and accessed from several sides. The slide 10 as well as the drive 11 are below the walk-on cover.

It is provided that the slide 10 and the carrier 1 are formed in one piece. However, it is also possible to form them out of two pieces, in particular in cases of maintenance. In this case the carrier then may also be hardened and can be exchanged simpler if worn out.

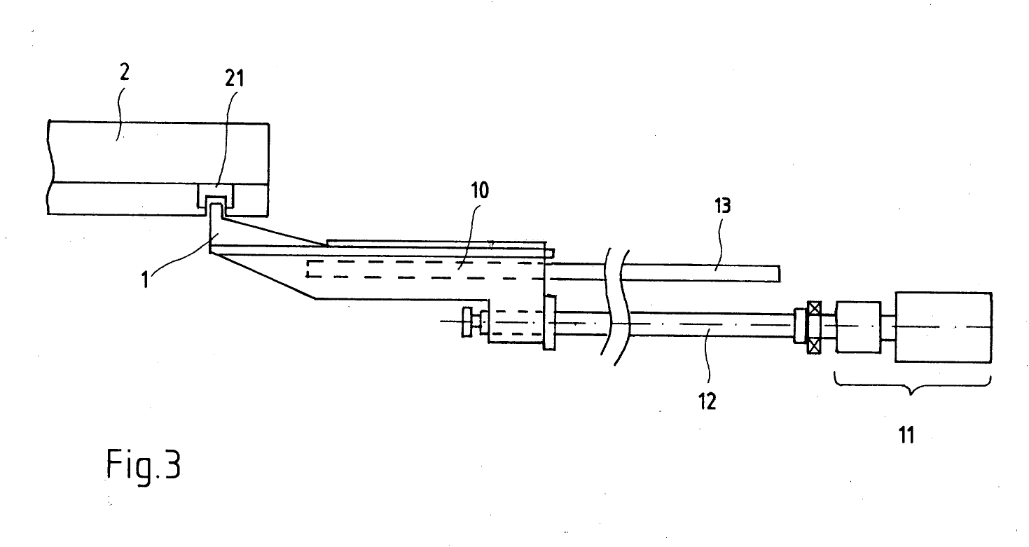

In FIG. 3 the co-operation of the carrier 1 with the pallet 2 is shown in a side view. The carrier 1, which is arranged at the slide 10, engages on the lower surface of the pallet 2 into a claw 21. The claw 21 is arranged below the pallet, it does not project.

For the guide of the slide 10 on the driving spindle 12 a guide rail 13 is provided. The driving unit 11 comprises a motor and a coupling. The driving spindle 12 is supported on bearings. The construction is simple and reliable.

The carrier 1 is linear designed rectangular to the direction of movement of the slide 10, in order to achieve a lateral (rectangular) threading of the pallet 2 via the claw 21 to the carrier 1.

Although the invention has been described using detailed examples which are shown in greatest detail it is pointed out that this is for explanation only and that the invention is not necessarily limited to it, because alternative examples and methods will become clear for experts with view of the disclosure. Accordingly changes are taken into consideration which can be carried out without deviation from the content of the described invention.

1. Pallet changing system for changing the pallet bearing the workpiece which has to be machined in a machine tool, in particular in a machining center, wherein a carrier, which can be driven, moves the pallet between a machining table in the machine tool and a set-up point outside the machine tool, characterised in that the carrier (1) is designed in such a way that it serves for connecting the pallet with the carrier (1) by means of the movement of the machining table.

2. Pallet changing system according to claim 1, characterised in that the carrier (1) is below the pallet (2) during the connection therewith and the pallet (2), respectively a coupling part or a claw, is connected, respectively threaded, to the carrier (1) by means of a movement of the pallet (2) caused by a movement of the machining table.

3. Pallet changing system according to claim 1, characterised in that the carrier (1) is arranged on a slide (10) which can be moved on a guide rail.

4. Pallet changing system according to claim 1, characterised in that for connecting the pallet (2) with the carrier (1) a claw (21), preferably a claw which does not project, respectively is hidden, is arranged below the pallet (2).

5. Pallet changing system according to claim 1, characterised by an interlocking connection between the pallet (2) and the carrier (1).

6. Pallet changing system according to claim 1, characterised in that for the guide of the slide (10) a guide rail (13) is provided and a driving unit (11) drives the slide (10) via the driving spindle (12).

7. Pallet changing system according to claim 1, characterised in that the carrier (1) is linear designed rectangular to the direction of movement of the slide (10) in order to obtain a lateral, preferably rectangular threading of the pallet (2) via the claw (21) to the carrier.

8. Pallet changing system according to claim 1, characterised in that a frame (3) is provided which carries the pallet (2) outside the machine tool (6) and forms the set-up point (30).

9. Pallet changing system according to one or more of the preceding claims, characterised in that the frame (3) has a channel (31) for receiving the carrier drive (11).

10. Pallet changing system according to claim 1, characterized in that between set-up point (30) and machining table a machine door (61) is provided in order to lock the working room of the machine tool.

11. Pallet changing system according to claim 1, characterised in that the carrier (1) grasps the pallet (2) on its off-center region.

12. Pallet changing system according to claim 1, characterised by at least two set-up points (30, 30′) per machine tool (6).

13. Pallet changing system according to claim 1, characterised in that at least two set-up points (30, 30′) are provided, which are arranged parallel in front of the working room (60), respectively the machine doors (61), in such a way that the pallet change from, respectively into, the working room (60) is carried out each time to the same set-up point (30, 31), from where the pallet (2) has been conveyed into the working room (60).

14. Pallet changing system according to claim 1, characterised in that the carrier (1) grasps the pallet (2) at its side opposite to the machining spindle of the machine tool (6).

15. Pallet changing system according to claim 1, characterised by an indexing or defining the pallet on the set-up point.

16. Pallet changing system according to claim 1, characterised in that the frame (3) has at its side facing the pallet (2) and/or the base of the channel (31) a surface which is diagonally inclined/lowered in the direction of the machine tool (6).

17. Pallet changing system according to claim 1, characterised in that the channel (31) is provided at its side facing the pallet (2) with an elastic sealing which can recede in the region of the carrier (1) during a movement of the carrier (1).

18. Pallet changing system according to claim 1, characterised in that the channel (31) has at its end facing the machine tool (6) a door or shutter which can, in particular, be controlled.

19. Pallet changing system according to claim 1, characterised in that a cleaning device is provided in order to keep the lower surface of the pallet and/or the upper surface of the frame free of chips or the like.

20. Pallet changing system according to claim 1, characterised in that the cleaning device is provided with a stripper which is supported by a slide and can be driven by the carrier drive.

21. Pallet changing system according to claim 1, characterised in that the cleaning device has an arm with rinsing nozzles for liquid and/or gaseous cleaning agents which is supported by a slide and can be driven by the carrier drive.

22. Pallet changing system according to claim 1, characterised in that the machine door (61) has an opening for the carrier (1) which can, if necessary, also be locked, in order to position the carrier in the working room (60) while the machine door (61) is otherwise closed.

23. Pallet changing system according to claim 1, characterised in that at least one connection for liquid and/or gaseous cleaning agent is provided on the carrier (1), and the cleaning agent reaches the rinsing nozzle of the pallet via the connection, when the carrier (1) co-operates with the pallet (2).

24. Pallet changing system according to claim 1, characterised in that a dismountable tilt resisting strip, which engages with an undercut of the guide groove (32) of the pallet (2), is provided at the guide rail (32) for the pallet (2).

25. Pallet changing system according to claim 1, characterised in that a safety switch is provided at the tilt resisting strip.

26. Pallet changing system according to claim 1, characterised in that the drive (11) of the carrier (1) is designed hydraulic, servopneumatic or electric or electromechanical and pulling means, in particular belts or chains or pinion rack drives, threaded spindles, linear motors or servodrives, are used.

27. Pallet changing system according to claim 1, characterised in that the control parameters of the carrier drive can be changed load-controlled.

28. Pallet changing system according to claim 1, characterised in that the movement of the carrier is controlled interpolating with the movement of the table in order to thread, respectively separate, the carrier (1).

29. Pallet changing system according to claim 1, characterised in that the carrier (1) can be separated from the pallet (2) when the pallet (2) stands on the set-up point (30).

30. Pallet changing system according to claim 1, characterised by a rotatable set-up point (30).

31. Pallet changing system according to claim 1, characterised in that the carrier (1) grasps the pallet (2) centrally.

32. Pallet changing system according to claim 1, characterised in that the pallet (2) can be rotated on the set-up point (30) around the carrier (1).

33. Pallet changing system according to claim 1, characterised in that two or more claws (21) are arranged on the lower surface of the pallet (2).

34. Method for changing a pallet in a machine tool, in particular in a machining center, the pallet being pulled off, respectively being moved back, from the machining table in the machine tool by means of a carrier to a set-up point outside the machine tool, wherein during pulling off the pallet firstly the carrier is positioned in the working room of the machine tool, and subsequently the pallet is connected by means of a movement of the machining table with the carrier and after that the carrier draws the pallet to the set-up point.

35. Method according to claim 34, characterised in that the pallet is conveyed each time after machining of the workpiece out of the workroom to the set-up point from which it has been conveyed into the working room.

36. Method according to claim 34, characterised in that the positioning of the carrier in the working room is carried out during the machining or immediately after the machining of the workpiece.

37. Method according to claim 34, characterised in that the positioning of the carrier in the working room is carried out while the machine door is closed or almost closed.

38. Pallet, in particular for a pallet changing system according to claim 1, wherein the pallet has guide means for guiding the pallet between the set-up point and the machining table, as well as a claw which can grasp the pallet from a carrier for transportation purposes, characterised in that the claw (21) is located beneath the pallet (2).

39. Pallet according to claim 38, characterised in that the pallet (2) has rinsing nozzles for liquid and/or gaseous cleaning agent.

40. Pallet according to claim 38, characterised in that the claw (21) is arranged in particular hidden and designed in such a way that an interlocking connection, which is in particular dirt-proof, is obtained between the carrier (1) and the claw (21) on engaging.

41. Pallet according to claim 38, characterised in that the rinsing nozzles which are each time arranged in front seen in the transport direction of the pallet are supplied with cleaning agent.

42. Pallet according to claim 38, characterized in that the carrier (1) and the claw (21) have a co-operating coupling through which the rinsing nozzles are supplied with cleaning agent.

43. Machining center with a machine tool for machining workpieces clamped on pallets and a pallet changing system according to one or more of the claims 1 to 33.
